(19) United States
(12) Patent Application Publication
(10) Pub. No.: US 2026/0309163 A1
(43) Pub. Date: Oct. 8, 2026

(54) ADJUSTABLE IMPELLER CASING STRUCTURE FOR CENTRIFUGAL COMPRESSOR

(71) Applicant: Harbin Engineering University, Harbin City (CN)

(72) Inventors: Chen LIU, Harbin City (CN); Shaoran DU, Harbin City (CN); Yipeng CAO, Harbin City (CN); Jiaxuan LIN, Harbin City (CN); Junqiao WANG, Harbin City (CN); Wending WANG, Harbin City (CN); Xiaochen ZHAO, Harbin City (CN); Jie YANG, Harbin City (CN)

(21) Appl. No.: 19/560,960

(22) Filed: Mar. 9, 2026

(30) Foreign Application Priority Data
Apr. 3, 2025 (CN) 202510414432.5

(51) Int. Cl. F04D 29/42; F04D 17/10

(52) U.S. Cl. CPC F04D 29/4206; F04D 17/10

(57) ABSTRACT

An adjustable impeller casing structure for a centrifugal compressor includes a leading-edge impeller casing and a trailing-edge impeller casing arranged sequentially in an axial direction, and an inlet clearance is provided between the leading-edge impeller casing and the trailing-edge impeller casing. The leading-edge impeller casing includes multiple leading-edge impeller casing units distributed uniformly in a circumferential direction. The inlet bypass recirculation structure includes a recirculation structure outer wall, and a trailing edge of the recirculation structure outer wall is fixedly connected with the trailing-edge impeller casing. Leading-edge impeller casing fixing structures are respectively fixedly provided on outer side walls of the leading-edge impeller casing units. Fixing structure cavities respectively corresponding to the leading-edge impeller casing fixing structures in a one-to-one manner are fixedly provided on the recirculation structure outer wall, and each of the leading-edge impeller casing fixing structures is provided with a radial adjustment mechanism.

### CROSS-REFERENCE TO RELATED APPLICATION

This patent application claims the benefit and priority of Chinese Patent Application No. 202510414432.5, entitled "ADJUSTABLE IMPELLER CASING STRUCTURE FOR CENTRIFUGAL COMPRESSOR" filed on Apr. 03, 2025, the disclosure of which is incorporated by reference herein in its entirety as part of the present application.

### TECHNICAL FIELD

The present disclosure relates to the technical field of centrifugal compressors, and in particular to an adjustable impeller casing structure for a centrifugal compressor.

### BACKGROUND

A turbocharging technology has been widely applied in the field of marine low-speed diesel engines thanks to its advantages such as energy saving, noise reduction and improved economy. Also, with the development of turbocharger centrifugal compressors with high pressure ratio and high flow, aerodynamic noise has become the key factor restricting the development thereof.

The maximum acoustic power of aerodynamic noise of the centrifugal compressor mainly occurs at an impeller part, and for a semi-open centrifugal compressor, factors causing the aerodynamic noise at the impeller part are different under different operating conditions. Under a low-rotational-speed operating condition, the aerodynamic noise mainly occurs between an impeller and an inlet pipe and between the impeller and a diffuser and is dipole noise caused by stator-rotor interaction. While under a high-rotational-speed operating condition, in addition to the noise caused by the stator-rotor interaction, the aerodynamic noise further includes dipole noise caused by blade leading-edge shock waves.

In current studies, an increase in blade tip clearance may weaken the blade leading-edge shock waves, thereby reducing the noise. However, this method still has some drawbacks. First, the performance of the compressor is reduced, the increase in the blade tip clearance causes an increase in leakage flow of the blade tip clearance, results in the aggravation of internal flow loss of the impeller, and thus reduces the performance of the compressor. Second, this method is limited to application conditions, the increase in the blade tip clearance can only reduce the aerodynamic noise under the high-rotational-speed condition, but under the low-rotational-speed condition, the increase in the blade tip clearance increase the internal flow loss of the impeller, reduce the performance of the compressor, and also increase vortex noise of the compressor due to the increasing leakage flow of the blade tip clearance.

In view of the above situations, an adjustable impeller casing structure for a centrifugal compressor is provided in order to solve the problems in the above conventional art.

### SUMMARY

The embodiments aim to provide an adjustable impeller casing structure for a centrifugal compressor, in order to solve the problems in the above conventional art, meet the requirement for aerodynamic performance and reduce aerodynamic noise.

To achieve the above object, the present disclosure provides the following solutions.

The present disclosure provides an adjustable casing structure for a centrifugal compressor impeller, which includes an impeller body, an impeller casing and an inlet bypass recirculation structure.

The impeller casing circumferentially wraps the impeller body in a middle of the impeller casing.

The impeller casing includes a leading-edge impeller casing and a trailing-edge impeller casing arranged sequentially in an axial direction. An inlet clearance is provided between the leading-edge impeller casing and the trailing-edge impeller casing, and a clearance between the impeller body and the leading-edge impeller casing and a clearance between the impeller body and the trailing-edge impeller casing constitutes a centrifugal compressor blade tip clearance.

The leading-edge impeller casing includes multiple leading-edge impeller casing units distributed uniformly in a circumferential direction. The multiple leading-edge impeller casing units are connected end to end in the circumferential direction, and every two adjacent leading-edge impeller casing units of the multiple leading-edge impeller casing units are connected by means of a labyrinth sealing structure.

The inlet bypass recirculation structure includes a recirculation structure outer wall. The recirculation structure outer wall is arranged around an outside of the impeller casing. A trailing edge of the recirculation structure outer wall is fixedly connected with the trailing-edge impeller casing. A recirculation structure chamber is formed between the recirculation structure outer wall and the impeller casing, and the inlet clearance communicates with the centrifugal compressor blade tip clearance and the recirculation structure chamber.

Leading-edge impeller casing fixing structures are respectively fixedly provided on outer side walls of the multiple leading-edge impeller casing units. Fixing structure cavities corresponding to the leading-edge impeller casing fixing structures in a one-to-one manner are fixedly provided on the recirculation structure outer wall. The leading-edge impeller casing fixing structures are in nested connection to the fixing structure cavities, and each of the leading-edge impeller casing fixing structures is provided with a radial adjustment mechanism for adjusting a radial position of a corresponding one of the leading-edge impeller casing fixing structures.

In an implementation, the multiple leading-edge impeller casing includes six leading-edge impeller casing units distributed uniformly in the circumferential direction.

In an implementation, the radial adjustment mechanism includes a lead screw and a screw knob, the lead screw is rotatably connected to the recirculation structure outer wall and is fixed radially opposite to the recirculation structure outer wall. Each of the leading-edge impeller casing fixing structures is provided with a threaded hole in threaded connection to the lead screw, and the screw knob is connected to a radially outward end of the lead screw and is configured to rotate to drive the rotation of the lead screw.

In an implementation, an inner side of each of the fixing structure cavities is fixedly provided with a limiting collar. Each of the leading-edge impeller casing fixing structures is provided with an annular limiting groove corresponding to the limiting collar, and the limiting collar is arranged in the annular limiting groove in a clearance fit manner.

In an implementation, each of the leading-edge impeller casing fixing structures includes an axially inclined elliptical or streamlined structure. Each of the fixing structural cavities is a structural cavity adapted to a corresponding one of the leading-edge impeller casing fixing structures in shape.

In an implementation, the lead screw is rotatably connected to the recirculation structure outer wall by means of a bearing.

In an implementation, the screw knob is sleeved on the lead screw and is connected to the lead screw by means of a flat key.

In an implementation, the recirculation structure outer wall, the trailing-edge impeller casing and the fixing structure cavities are an integrated structure.

In an implementation, each of the multiple leading-edge impeller casing units and a corresponding one of the leading-edge impeller casing fixing structures the leading-edge impeller casing unit are an integrated structure.

The embodiments achieve the following technical effects compared with the conventional art.

The adjustable impeller casing structure for the centrifugal compressor provided by the embodiments can change the blade leading-edge tip clearance according to the demands, and can also reduce the aerodynamic noise of a centrifugal compressor on the basis of meeting the requirement for aerodynamic performance. Under a high-rotational-speed operating condition, by increasing the leading-edge blade tip clearance, leading-edge shock waves are weakened, and the aerodynamic noise is thus reduced. Under a low-rotational-speed operating condition, by decreasing the leading-edge blade tip clearance, the internal flow loss of an impeller is reduced, the performance of the compressor is improved, and the vortex noise of the compressor is also reduced due to the decreasing leakage flow of the blade tip clearance.

The adjustable impeller casing structure for the centrifugal compressor provided by the embodiments can not only be used under the high and low rotational speed conditions, but also be correspondingly adjusted according to a variation in the blade tip clearances due to the deformation caused by the impact of a heat load, a centrifugal force and an aerodynamic load on the blades during the operation of the compressor, such that the performance of the compressor is improved, and the safety margin of the compressor is increased.

From the perspective of changing a blade tip clearance structure itself, the embodiments employ a mechanical transmission structure which is relatively safe and reliable, and is provided with radial limiting structures (i.e., the limiting collar and the annular limiting groove), such that safe operation of the compressor can be guaranteed without problems such as blade wear.

### BRIEF DESCRIPTION OF THE DRAWINGS

In order to illustrate the technical solutions in the embodiments of the present disclosure or the conventional art more clearly, a brief introduction to the drawings required for the embodiments will be provided below. Obviously, the drawings in the following description are merely some of the embodiments of the present disclosure, and those of ordinary skill in the art can also obtain other drawings according to these drawings without involving any inventive effort.

FIG. 1 shows a structural schematic diagram of an adjustable impeller casing structure for a centrifugal compressor according to an embodiment of the present disclosure;

FIG. 2 shows a schematic partial enlarged view of part A in FIG. 1;

FIG. 3 shows a schematic partial enlarged view of part B in FIG. 1;

FIG. 4 shows a side view of a leading-edge impeller casing according to the embodiment of the present disclosure;

FIG. 5 shows a sectional view of a recirculation structure outer wall and a trailing-edge impeller casing according to the embodiment of the present disclosure; and

FIG. 6 shows a sectional view of a radial adjustment mechanism according to the embodiment of the present disclosure.

List of the reference characters: 1 impeller body; 2 impeller casing; 3 inlet bypass recirculation structure; 4 leading-edge impeller casing; 5 trailing-edge impeller casing; 6 inlet clearance; 7 leading-edge impeller casing unit; 8 labyrinth sealing structure; 9 recirculation structure outer wall; 10 recirculation structure chamber; 11 leading-edge impeller casing fixing structure; 12 fixing structure cavity; 13 radial adjustment mechanism; 14 lead screw; 15 screw knob; 16 threaded hole; 17 limiting collar; 18 annular limiting groove.

### DETAILED DESCRIPTION OF THE EMBODIMENTS

The technical solutions in the embodiments of the present disclosure will be clearly and completely described below in conjunction with the accompanying drawings in the embodiments of the present disclosure. Apparently, the embodiments described are merely some rather than all of the embodiments of the present disclosure. On the basis of the examples in the present disclosure, all the other examples that would have been obtained by those of ordinary skill in the art without involving any creative effort shall fall within the scope of protection of the present disclosure.

The embodiments aim to provide an adjustable impeller casing structure for a centrifugal compressor, in order to solve the problems in the conventional art, meet the requirement for aerodynamic performance and reduce aerodynamic noise.

In order to make the object, features and advantages of the embodiments more clearly understood, the present disclosure will be further described in detail below with reference to the accompanying drawings and specific implementations.

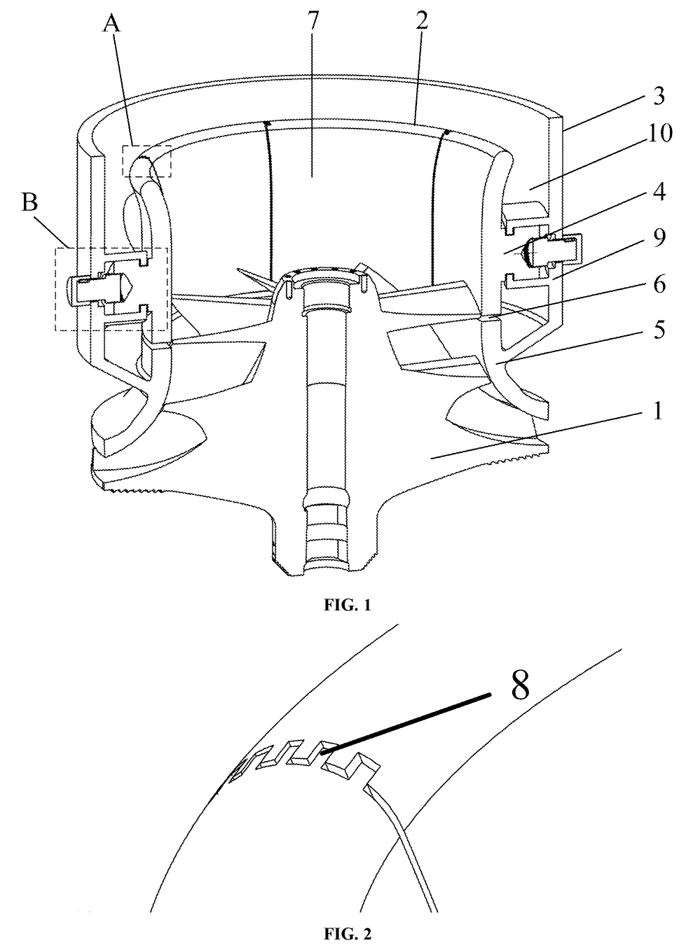

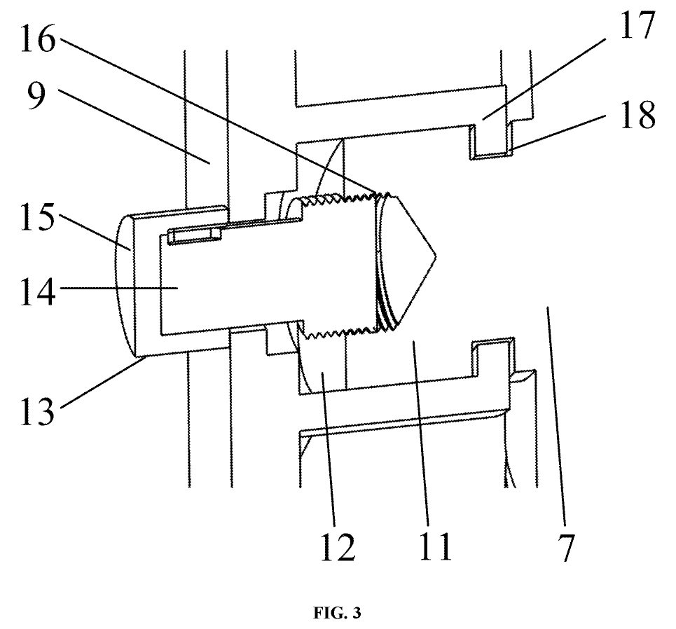

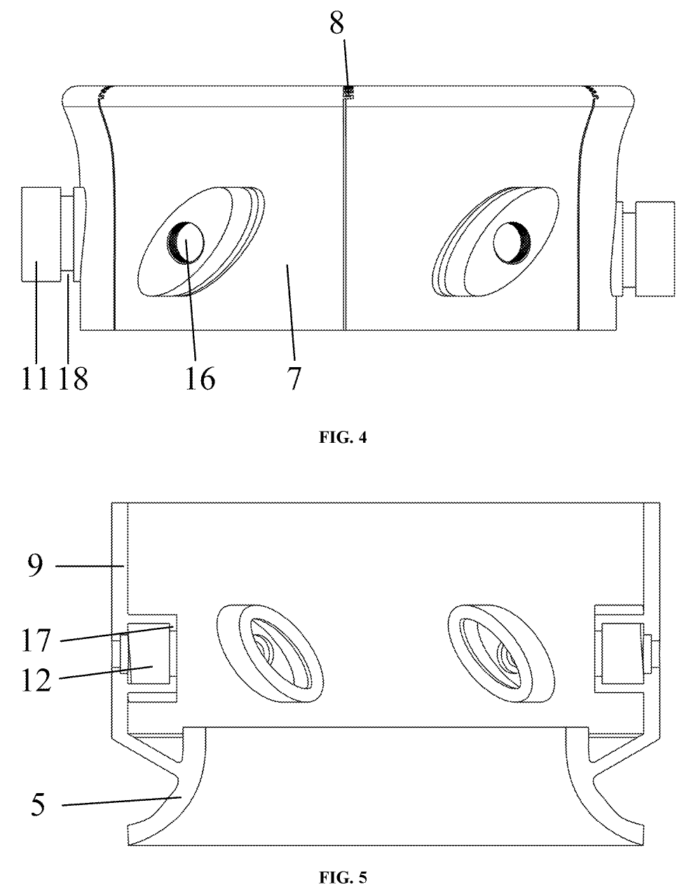

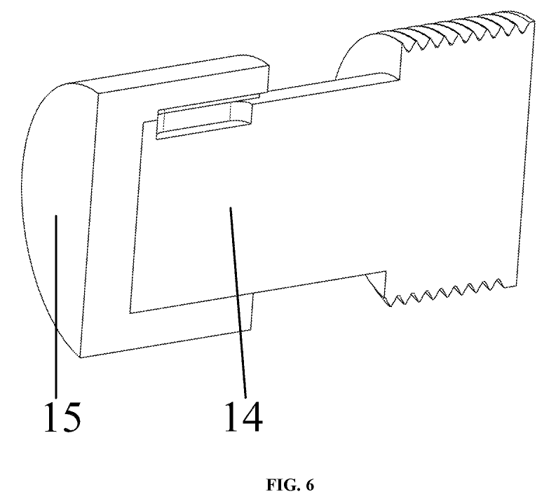

As shown in FIGS. 1-6, an embodiment provides an adjustable impeller casing structure for a centrifugal compressor, which includes an impeller body 1, an impeller casing 2 and an inlet bypass recirculation structure 3.

The impeller casing 2 circumferentially wraps the impeller body 1 in the middle of the impeller casing 2.

The impeller casing 2 includes a leading-edge impeller casing 4 and a trailing-edge impeller casing 5 arranged sequentially in an axial direction. An inlet clearance 6 is provided between the leading-edge impeller casing 4 and the trailing-edge impeller casing 5. A clearance between the impeller body 1 and the leading-edge impeller casing 4 and a clearance between the impeller body 1 and the trailing-edge impeller casing 5 constitutes a centrifugal compressor blade tip clearance;

The leading-edge impeller casing 4 includes multiple leading-edge impeller casing units 7 distributed uniformly in a circumferential direction. The leading-edge impeller casing units 7 are connected end to end in the circumferential direction. Every two adjacent leading-edge impeller casing units 7 are connected by means of a labyrinth sealing structure 8. The labyrinth sealing structure 8 can ensure the air tightness of the leading-edge impeller casing 4, and the clearance margin of the labyrinth sealing structure 8 can also be used to provide a space for radial movement of each part of the leading-edge impeller casing 4.

In this embodiment, the leading-edge impeller casing 4 includes six leading-edge impeller casing units 7 distributed uniformly in the circumferential direction. A variation of the leading-edge blade tip clearance in the circumferential direction is allowed to be uniform as much as possible, a variation of a central leading-edge blade tip clearance and the variation of the leading-edge blade tip clearance on a labyrinth seal side of each part of the leading-edge impeller casing unit 7 have only 13.3% errors.

The inlet bypass recirculation structure 3 includes a recirculation structure outer wall 9. The recirculation structure outer wall 9 is arranged around the outside of the impeller casing 2. A trailing edge of the recirculation structure outer wall 9 is fixedly connected with the trailing-edge impeller casing 5. A recirculation structure chamber 10 is formed between the recirculation structure outer wall 9 and the impeller casing 2, and the inlet clearance 6 communicates with the centrifugal compressor blade tip clearance and the recirculation structure chamber 10.

A gas enters a compressor impeller passage axially through the leading-edge impeller casing 4, a rotating shaft drives the impeller body 1 to rotate, and blades compress the gas entering the impeller passage under the action of a centrifugal force and the restriction of the trailing-edge impeller casing 5, to convert mechanical energy into kinetic energy and pressure energy of the gas, and the gas is then discharged at an impeller trailing edge.

The gas trapped between the impeller body 1 and the leading-edge impeller casing 4 and the trailing-edge impeller casing 5 flows back from the inlet clearance 6 to the recirculation structure chamber 10, and is then mixed with normal intake air to axially enter the centrifugal compressor impeller passage through the leading-edge impeller casing 4.

A leading-edge impeller casing fixing structure 11 is fixedly provided on an outer side wall of each of the leading-edge impeller casing units 7. Fixing structure cavities 12 respectively corresponding to the leading-edge impeller casing fixing structures 11 in a one-to-one manner are fixedly provided on the recirculation structure outer wall 9. The leading-edge impeller casing fixing structure 11 is in nested connection to the fixing structure cavity 12. By using the nested connection structure, the circumferential position of the leading-edge impeller casing unit 7 is fixed, but the radial movement of the leading-edge impeller casing unit 7 is not restricted, and each of the leading-edge impeller casing fixing structures 11 is provided with a radial adjustment mechanism 13 for adjusting a radial position of the leading-edge impeller casing fixing structure 11.

In this embodiment, the radial adjustment mechanism 13 includes a lead screw 14 and a screw knob 15, the lead screw 14 is rotatably connected to the recirculation structure outer wall 9 and fixed radially opposite to the recirculation structure outer wall 9. The leading-edge impeller casing fixing structure 11 is provided with a threaded hole 16 in threaded connection to the lead screw 14, and the screw knob 15 is connected to a radially outward end of the lead screw 14 and is configured to rotate to drive the rotation of the lead screw 14. The radial position of the leading-edge impeller casing unit 7 can be finely adjusted by means of the rotation of the lead screw 14, and thus the blade leading-edge tip clearance is changed. Since the blade tip clearance is a small structure, most of the blade tip clearance is around 0.65 mm, and a variation range of the blade tip clearance is also smaller. For the fine radial movement of the leading-edge impeller casing unit 7, the thread pitch of the threaded hole 16 and the thread pitch of the lead screw 14 can be decreased to achieve the fine radial movement.

As a fixing structure, the inlet bypass recirculation structure 3 plays a role of fixing the lead screw 14 and the screw knob 15 in the radial direction and achieves the function of the radial adjustment mechanism 13. The gas recirculation has the effect that a high-pressure low-velocity flow trapped in a blade tip region can be sucked into the recirculation structure chamber 10 through the inlet clearance 6 on the basis of the differential pressure principle, is then mixed with the normal intake air and axially enters the centrifugal compressor impeller passage through the leading-edge impeller casing 4, such that the surge of the centrifugal compressor can be relieved effectively, and thus a stable operation range of the centrifugal compressor can be widened.

In this embodiment, the inner side of the fixing structure cavity 12 is fixedly provided with a limiting collar 17. The leading-edge impeller casing fixing structure 11 is provided with an annular limiting groove 18 corresponding to the limiting collar 17, and the limiting collar 17 is arranged in the annular limiting groove 18 in a clearance fit manner. By means of a matched structure of the limiting collar 17 and the annular limiting groove 18, a radial movement distance of the leading-edge impeller casing unit 7 can be controlled within a safety margin, and a fit clearance can be determined by testing, such that blade wear and collision caused by an excessively small the leading-edge blade tip clearance can be prevented, and the significant reduction in compressor efficiency due to an excessively large the leading-edge blade tip clearance can also be prevented.

In order not to interfere with the flow of the gas within the recirculation structure chamber 10, the leading-edge impeller casing fixing structure 11 includes an axially inclined elliptical or streamlined structure. The fixing structural cavity 12 is a structural cavity adapted to the leading-edge impeller casing fixing structure 11 in shape. In this embodiment, the leading-edge impeller casing fixing structure 11 is an elliptical structure. The streamlined structure includes a wing-type structure. The shape of the leading-edge impeller casing fixing structure 11 is not limited to the above shapes, as long as these shapes meet the functional requirements of the present disclosure.

In this embodiment, the lead screw 14 is rotatably connected to the recirculation structure outer wall 9 by means of a bearing.

In this embodiment, the screw knob 15 is sleeved on the lead screw 14 and is connected to the lead screw 14 by means of a flat key.

In this embodiment, the recirculation structure outer wall 9, the trailing-edge impeller casing 5 and the fixing structure cavities 12 are an integrated structure.

In this embodiment, the leading-edge impeller casing unit 7 and the leading-edge impeller casing fixing structures 11 thereon are an integrated structure.

The present disclosure has six screw knobs 15 which are controlled by a controller to rotate simultaneously. A rotational speed sensor sends a signal to the controller when detecting the reduction of a rotational speed of the centrifugal compressor. The controller controls the rotation of the six screw knobs 15 simultaneously, and the controller can control the rotation of the screw knobs 15 by controlling devices such as a rotating motor or a rotating cylinder, causing six parts of leading-edge impeller casing units 7 to simultaneously move inward radially, decreasing the leading-edge blade tip clearance, such that the internal flow loss of the impeller is reduced, the performance of the compressor is improved, and the vortex noise of the compressor is also reduced due to the decreasing leakage flow of the blade tip clearance. When detecting a rise in the rotational speed of the centrifugal compressor, the rotational speed sensor sends a signal to the controller, the controller simultaneously controls the rotation of the six screw knobs 15, allowing the six parts of leading-edge impeller casing units 7 to simultaneously move outward radially, increasing the leading-edge blade tip clearance, such that leading-edge shock waves are weakened, and the aerodynamic noise is reduced.

In the present disclosure, the principle and implementations of the present disclosure are described herein by using specific examples, the above descriptions of the above embodiments are merely intended to help understand the methods and core idea of the disclosure. Meanwhile, for those of ordinary skill in the art, changes may be made to the specific embodiments and the scope of application according to the concept of the present disclosure. In summary, the content of the description should not be construed as a limitation to the present disclosure.

What is claimed is:

1. An adjustable impeller casing structure for a centrifugal compressor, comprising an impeller body, an impeller casing and an inlet bypass recirculation structure;
wherein the impeller casing circumferentially wraps the impeller body in a middle of the impeller casing;
the impeller casing comprises a leading-edge impeller casing and a trailing-edge impeller casing arranged sequentially in an axial direction, an inlet clearance is provided between the leading-edge impeller casing and the trailing-edge impeller casing, and a clearance between the impeller body and the leading-edge impeller casing and a clearance between the impeller body and the trailing-edge impeller casing constitutes a centrifugal compressor blade tip clearance;
the leading-edge impeller casing comprises a plurality of leading-edge impeller casing units distributed uniformly in a circumferential direction, the plurality of leading-edge impeller casing units are connected end to end in the circumferential direction, and every two adjacent leading-edge impeller casing units of the plurality of leading-edge impeller casing units are connected by means of a labyrinth sealing structure;
the inlet bypass recirculation structure comprises a recirculation structure outer wall, the recirculation structure outer wall is arranged around an outside of the impeller casing, a trailing edge of the recirculation structure outer wall is fixedly connected with the trailing-edge impeller casing, a recirculation structure chamber is formed between the recirculation structure outer wall and the impeller casing, and the inlet clearance communicates with the centrifugal compressor blade tip clearance and the recirculation structure chamber; and
leading-edge impeller casing fixing structures are respectively fixedly provided on outer side walls of the plurality of leading-edge impeller casing units, fixing structure cavities respectively corresponding to the leading-edge impeller casing fixing structures in a one-to-one manner are fixedly provided on the recirculation structure outer wall, the leading-edge impeller casing fixing structures are respectively in nested connection to the fixing structure cavities, and each of the leading-edge impeller casing fixing structures is provided with a radial adjustment mechanism for adjusting a radial position of a corresponding one of the leading-edge impeller casing fixing structures.

2. The adjustable impeller casing structure for the centrifugal compressor according to claim 1, wherein the plurality of leading-edge impeller casing comprises six leading-edge impeller casing units distributed uniformly in the circumferential direction.

3. The adjustable impeller casing structure for the centrifugal compressor according to claim 1, wherein the radial adjustment mechanism comprises a lead screw and a screw knob, the lead screw is rotatably connected to the recirculation structure outer wall and is fixed radially opposite to the recirculation structure outer wall, each of the leading-edge impeller casing fixing structures is provided with a threaded hole in threaded connection to the lead screw, and the screw knob is connected to a radially outward end of the lead screw and is configured to rotate to drive rotation of the lead screw.

4. The adjustable impeller casing structure for the centrifugal compressor according to claim 1, wherein an inner side of each of the fixing structure cavities is fixedly provided with a limiting collar, each of the leading-edge impeller casing fixing structures is provided with an annular limiting groove corresponding to the limiting collar, and the limiting collar is arranged in the annular limiting groove in a clearance fit manner.

5. The adjustable impeller casing structure for the centrifugal compressor according to claim 1, wherein each of the leading-edge impeller casing fixing structures comprises an axially inclined elliptical or streamlined structure; each of the fixing structure cavities is a structural cavity adapted to a corresponding one of the leading-edge impeller casing fixing structures in shape.

6. The adjustable impeller casing structure for the centrifugal compressor according to claim 3, wherein the lead screw is rotatably connected to the recirculation structure outer wall by means of a bearing.

7. The adjustable impeller casing structure for the centrifugal compressor according to claim 3, wherein the screw knob is sleeved on the lead screw and is connected to the lead screw by means of a flat key.

8. The adjustable impeller casing structure for the centrifugal compressor according to claim 1, wherein the recirculation structure outer wall, the trailing-edge impeller casing and the fixing structure cavities are an integrated structure.

9. The adjustable impeller casing structure for the centrifugal compressor according to claim 1, wherein each of the plurality of leading-edge impeller casing units and a corresponding one of the leading-edge impeller casing fixing structures on the leading-edge impeller casing unit are an integrated structure.
